(19) United States
(12) Patent Application Publication
(10) Pub. No.: US 2008/0069744 A1
(43) Pub. Date: Mar. 20, 2008

(54) Fuel Reformer

(75) Inventors: Koichi Machida, Tokyo (JP); Takatoshi Furukawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Hino Motors LTD., Hino-shi (JP)

(21) Appl. No.: 11/576,587

(22) PCT Filed: Oct. 3, 2005
(86) PCT No.: PCT/JP05/18273

§ 371 Date: Apr. 3, 2007

(30) Foreign Application Priority Data
Oct. 4, 2004 (JP) 2004-291162

(51) Int. Cl. B01J 19/12

(52) U.S. Cl. 422/186.04

(57) ABSTRACT

Provided are an electrically conductive pipe 12 providing an earth electrode, a mixed gas flow passage 14 which guides a mixed gas of fuel with air into the conductive pipe 12 and a high voltage electrode which impresses high voltage between the same and the conductive pipe 12 as the earth electrode to generate plasma for reformation of the fuel guided from the flow passage 14 into the conductive pipe 12 so as to efficiently perform the reformation of the fuel which can be effectively utilized for a field of, for example, reduction of a NOₓ-occlusion reduction catalyst and of a fuel cell.

### TECHNICAL FIELD

The present invention relates to a fuel reformer for reduction of a NOₓ-occlusion reduction catalyst or preparation of, for example, hydrogen used in a fuel cell.

### BACKGROUND ART

Conventionally, exhaust purification has been tried by an exhaust purifying catalyst incorporated in an exhaust pipe Known as such exhaust purifying catalyst is a NOₓ-occlusion reduction catalyst having a feature of oxidizing NOₓ in exhaust gas for temporary occlusion in the form of nitrate salt when exhaust air/fuel ratio is lean, and decomposing and discharging NOₓ through intervention of unburned HC, CO and the like for reduction and purification when the O₂ concentration in the exhaust gas is lowered.

Known as the NOₓ-occlusion reduction catalysts having the above-mentioned feature is, for example, an alumina catalyst carrying platinum and barium or an alumina catalyst carrying platinum and potassium.

No further NOₓ can be occluded once an occluded NOₓ amount increases into saturation in the NOₓ-occlusion reduction catalyst, so that it is required to periodically lower the O₂ concentration in the exhaust gas flowing into the reduction catalyst to decompose and discharge NOₓ.

In an application to, for example, a gasoline engine, lowering the operational air/fuel ratio in the engine (operating the engine with rich air/fuel ratio) can lower the O₂ concentration in the exhaust gas and increase the reduction components such as unburned HC and CO in the exhaust gas for facilitation in decomposition and discharge of NOₓ; however, in use of a NOₓ-occlusion reduction catalyst in an exhaust emission control device for a diesel engine, it is difficult to operate the engine with rich air/fuel ratio.

This results in necessity of adding fuel (HC) such as light oil into the exhaust gas upstream of the NOₓ-occlusion reduction catalyst to react the added fuel as reducing agent with O₂ on the reduction catalyst to thereby lower the O₂ concentration in the exhaust gas (see, for example, Reference 1).

[Reference 1] JP2000-356127A

### SUMMARY OF THE INVENTION

### Problems to be Solved by the Invention

However, in such fuel addition upstream of a NOₓ-occlusion reduction catalyst, part of HC generated due to evaporation of the added fuel reacts with O₂ in the exhaust gas (combustion) on the NOₓ-occlusion reduction catalyst, and decomposition and discharge of NOₓ are started after the O₂ concentration becomes substantially zero in the atmosphere around the NOₓ-occlusion reduction catalyst. Thus, in an operational condition that a combustion temperature (about 220-250° C.) necessary for reaction of HC with O₂ (combustion) cannot be obtained on the NOₓ-occlusion reduction catalyst (for example, operation at reduced speed on city roads often congested with traffic) NOₓ cannot be efficiently decomposed and discharged by the reduction catalyst and the regeneration of the reduction catalyst does not efficiently progress disadvantageously resulting in lowering of recovery ratio of Oₓ-occlusion sites occupied in volume of the catalyst to deteriorate occlusion capacity.

In order to overcome the above problem, it has been recently proposed to arrange a cracking catalyst, which decomposes fuel into H₂ and CO, between the added fuel position and the NOₓ-occlusion reduction catalyst in the exhaust flow passage of the engine.

In this case, the added fuel as the reducing agent is decomposed into H₂ and CO by the upstream cracking catalyst, and the highly reactive H₂ and CO are reacted with O₂ in the exhaust gas (combustion) on the downstream NOₓ-occlusion reduction catalyst at a combustion temperature lower than the conventional HC combustion temperature, whereby the O₂ concentration in the atmosphere surrounding the reduction catalyst becomes substantially zero to start the decomposition and discharge of NOₓ, leading to efficient reduction of NOₓ by the highly reactive H and CO on the reduction catalyst. As a result, high NOₓ reduction ratio can be obtained even at a temperature region lower than that of conventional direct reaction of the generated HC on the NOₓ-occlusion reduction catalyst.

However, even if a cracking catalyst is arranged between the added fuel position and the NOₓ-occlusion reduction catalyst in the exhaust flow passage of the engine, it is difficult for the cracking catalyst to decompose the fuel such as light oil into H₂ and CO unless the exhaust temperature reaches as high as about 200° C. or so. Thus, it remains desired to develop a device capable of decomposing the fuel into H₂, CO and the like in a temperature lower than that in use of the cracking catalyst.

The invention was made in view of the above and has its object to provide a fuel reformer which can efficiently reforms fuel and can be effectively utilized in a field, for example, of reduction of a NOₓ-occlusion reduction catalyst or of fuel cell.

### Means or Measures for Solving the Problems

The invention is directed to a fuel reformer comprising an electrically conductive pipe providing an earth electrode,

a mixed gas flow passage for guiding a mixed gas of fuel with air into the conductive pipe and

a high voltage electrode for impression of high voltage between the same and the electrically conductive pipe as the earth electrode so as to generate plasma to reform the fuel guided from said mixed gas flow passage into the conductive pipe.

According to the above means, the following effect will be obtained.

The impression of high voltage between the high voltage electrode and the conductive pipe as earth electrode generates plasma, so that the fuel guided from the flow passage into the conductive pipe is effectively reformed.

Thus, by arranging the fuel reformer of the invention for example, upstream of a NOₓ-occlusion reduction catalyst in an exhaust flow passage of an engine for feeding of reformed H₂, CO and the like, fuel such as light oil can be decomposed into H₂, CO and the like at a temperature further lower than that in use of the cracking catalyst, thereby obtaining high NOₓ reduction ratio at a lower temperature region. The fuel reformer of the invention may be applicable also to a fuel cell and the like.

In the fuel reformer, at least either of a tip of the electrode or an inner surface of the conductive pipe can be sheathed by a dielectric so as to effect barrier discharge between the electrode and conductive pipe, whereby low-temperature plasma is generated by the barrier discharge, which enables reduction of electric power consumption.

In this case, it is desirable that the high voltage electrode is arranged via an electrode-supporting insulator on a support member, a base end of the dielectric sheathing the tip of the electrode being eaten into the end face of the electrode-supporting insulator, a distance from the tip of the electrode to the conductive pipe being made shorter than a distance between the electrode and the support member; thus, even if the support member is made of metal and thus may function as earth electrode, prevented is so-called surface creepage which is electric discharge from the base end of the dielectric via the end face of the electrode-supporting insulator and along the end face of the support member, and barrier discharge can be ensured from the tip of the electrode toward the conductive pipe to generate low-temperature plasma, resulting in improvement in efficiency.

When the end face of the electrode-supporting insulator is projected relative to the end face of the support member, accordingly the base end of the dielectric is eaten into the end face of the electrode-supporting insulator even if the base end of the dielectric is coplanar with the end face of the support member. As a result, the distance from the base end of the dielectric via the end face of the insulator to the end face of the support member is prolonged, so that, as is the above-mentioned case, the surface creepage is prevented and the barrier discharge can be ensured from the tip of the electrode toward the conductive pipe to generate low-temperature plasma, resulting in improvement in efficiency.

Moreover, it is preferable from the viewpoint of generating the low-temperature plasma more effectively that the electrode is closely fitted without gap to the dielectric sheathing the tip of the electrode.

In addition, the dielectric sheathing the tip of the high voltage electrode may be formed at its tip with a disc-like projection for guiding the mixed gas to a area generating plasma, which positively guides the mixed gas along the disc-like projection to the area generating plasma owing to the barrier discharge, whereby the fuel can be reformed further efficiently.

Also in a case where only the inner surface of the conductive pipe is covered or sheathed with dielectric, and the tip of the electrode is formed with a disc-like projection for guiding the mixed gas to the area generating plasma, as is the same with the above, the mixed gas is reliably guided along the disc-like projection to the area generating plasma through the barrier discharge, whereby the fuel can be reformed further efficiently.

The fuel reformer may be constructed such that arc discharge is performed between the high voltage electrode and the conductive pipe, leading to generation of high-temperature plasma, so that the mixed gas is enhanced in temperature, which is effective for reformation of the fuel.

In this case, the tip of the electrode may be formed with a disc-like projection for guiding the mixed gas to the area generating plasma. As a result, the mixed gas is reliably guided along the disc-like projection to the area generating plasma through the arc discharge, whereby the fuel can be reformed further efficiently.

Further, it is desirable in the fuel reformer that the conductive pipe is arranged via the pipe-supporting insulator on the support member, said insulator being formed with a frustoconical through-hole which is coaxial with the electrode and serves as a mixed gas flow passage tapered toward an internal space of the conductive pipe, a curved surface being provided from a tip of the frustoconical through-hole and with an inner diameter gradually expanded the inner surface of the conductive pipe being smoothly contiguous with the curved surface. As a result, a joint between the pipe-supporting insulator and the conductive pipe is out of alignment with a pointed transition between the tip of the frustoconical through-hole as the mixed gas flow passage and the curved surface, which prevents the plasma from being concentrated to the pointed transition whereby the plasma can be generated over a wide range, which is effective for efficient reformation of the fuel.

### EFFECTS OF THE INVENTION

According to a fuel reformer of the invention, excellent effects and advantages can be obtained such that reformation of the fuel can be efficiently conducted and effective utilization can be obtained for a field of reduction of a NOₓ-occlusion reduction catalyst, of a fuel cell and the like.

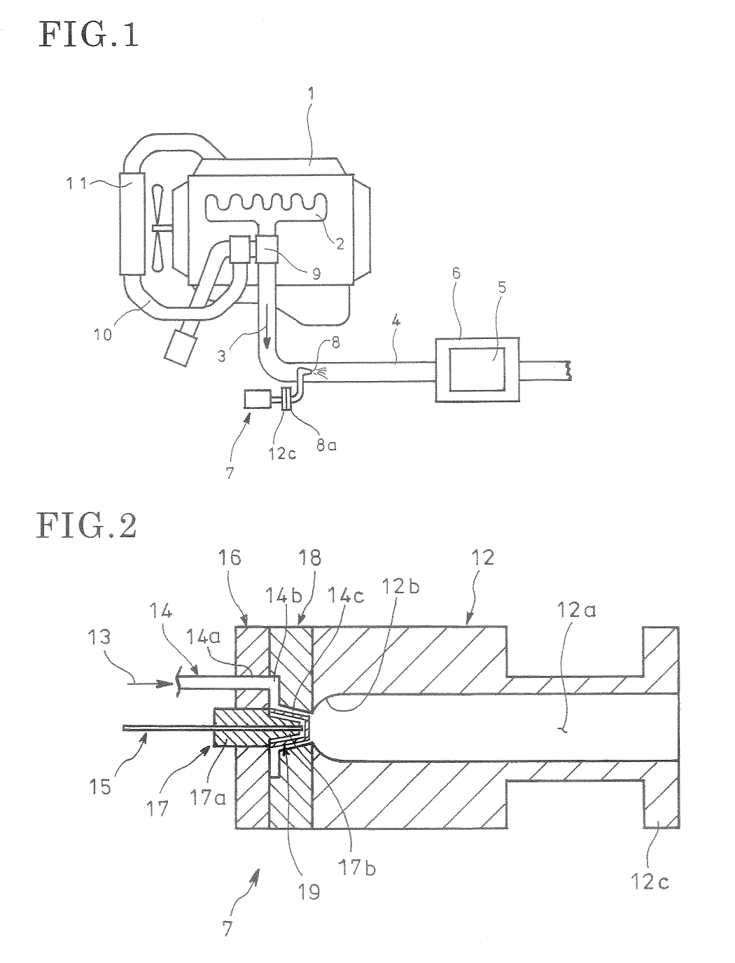

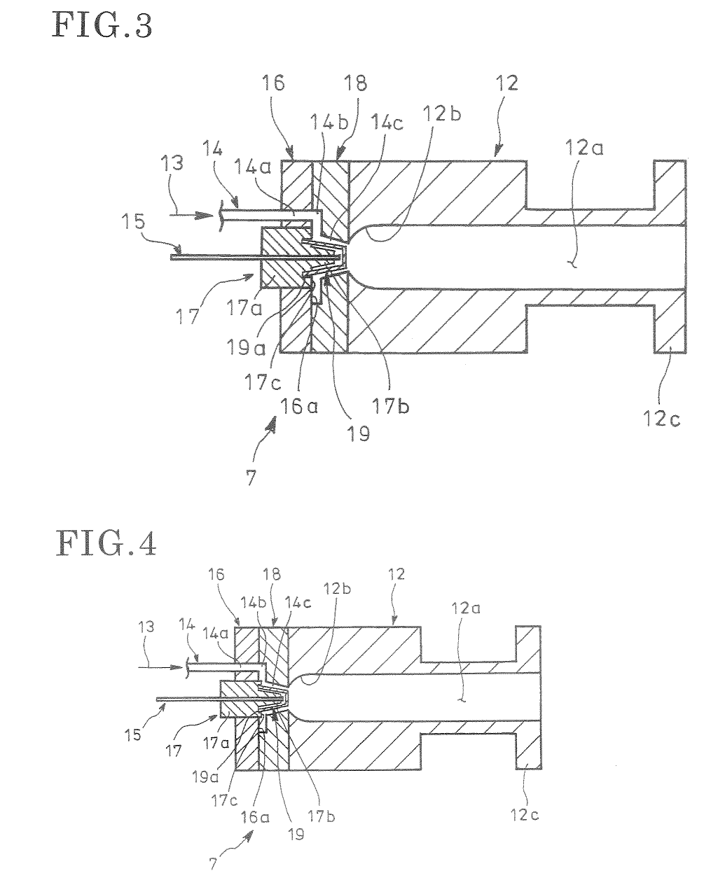

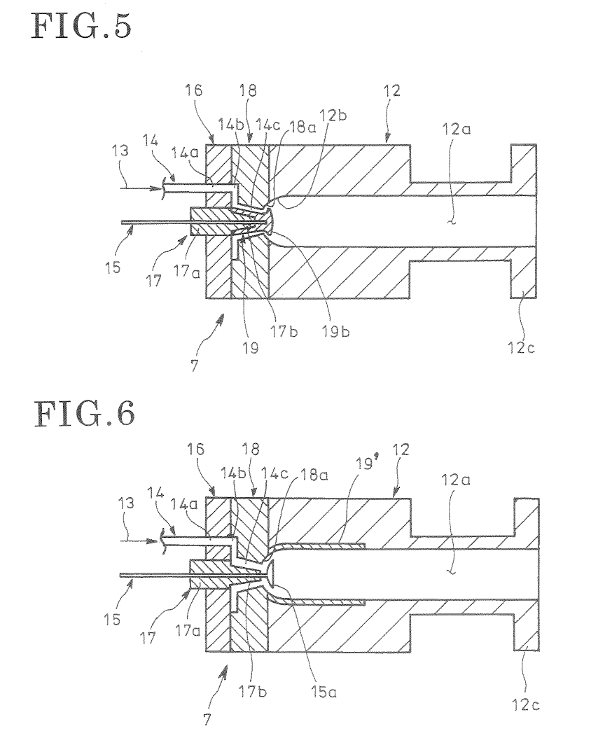

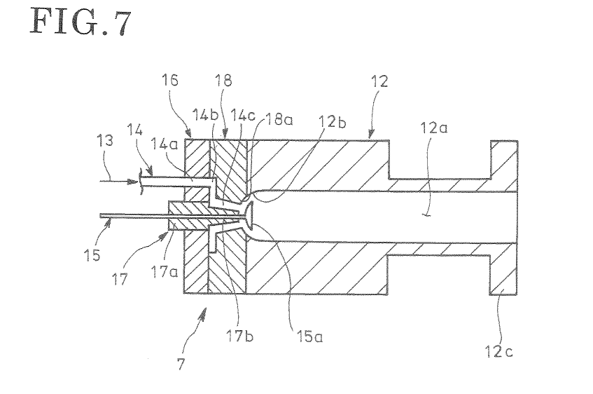

### BRIEF DESCRIPTION OF THE DRAWINGS

[FIG. 1] A schematic overall structure including the invention.

[FIG. 2] A sectional side elevation showing a first embodiment of the fuel reformer in FIG. 1

[FIG. 3] A sectional side elevation showing a second embodiment of the fuel reformer in FIG. 1.

[FIG. 4] A sectional side elevation showing a third embodiment of the fuel reformer in FIG. 1.

[FIG. 5] A sectional side elevation showing a fourth embodiment of the fuel reformer in FIG. 1.

[FIG. 6] A sectional side elevation showing a fifth embodiment of the fuel reformer in FIG. 1

[FIG. 7] A sectional side elevation showing a sixth embodiment of the fuel reformer in FIG. 1

### EXPLANATION OF THE REFERENCE NUMERALS

1 diesel engine
3 exhaust gas
5 NOₓ-occlusion reduction catalyst
7 fuel reformer
8 injection nozzle
12 electrically conductive pipe
12b curved surface
13 mixed gas
14 mixed gas flow passage
14c frustoconical through-hole
15 high voltage electrode
15a projection
16 support member
16a end face
17 electrode-supporting insulator
17c end face
18 pipe-supporting insulator
18a curved surface
19 dielectric
19a base end
19b projection
19′ dielectric

### BEST MODE FOR CARRYING OUT THE INVENTION

Embodiments of the invention will be described in conjunction with the drawings.

FIG. 1 shows an example including the invention in which a diesel engine 1 has an exhaust manifold 2 through which exhaust gas 3 is discharged to pass through an exhaust pipe 4. Incorporated in the exhaust pipe 4 is a flow-through type, honeycomb-structured NOₓ-occlusion reduction catalyst 5 carried by a casing 6. Inserted into and arranged in the exhaust pipe 4 upstream of the casing 6 is an injection nozzle 8 to which in turn a fuel reformer 7 is connected such that H₂, CO and the like reformed by the fuel reformer 7 are added via the nozzle 8 into the exhaust pipe 4 at an entry side of the casing 6.

In FIG. 1, reference numeral 9 denotes a turbocharger; 10, an intake pipe; and 11, an intercooler.

The fuel reformer 7 may comprise, as a first embodiment shown in FIG. 2, an electrically conductive pipe 12 providing an earth electrode, a mixed gas flow passage 14 which guides a mixed gas 13 of fuel such as light oil with air into the conductive pipe 12 and a high voltage electrode 15 for impression of high voltage between the same and the conductive pipe 12 as the earth electrode so as to generate plasma for reformation of the fuel guided from the passage 14 into the pipe 12.

The structure of the first embodiment shown in FIG. 2 will be described for details. The high voltage electrode 15 extends via an electrode-supporting insulator 17 axially of a disc-like support member 16. The support member 16 has one end face on which arranged via an pipe-supporting insulator 18 is the conductive pipe 12 as the earth electrode. The flow passage 14 is formed to extend through the support member 16 and insulator 18 to communicate with an internal space of the conductive pipe 12.

The electrode-supporting insulator 17 comprises a cylindrical portion 17a extending axially through the support member 16 and a frustoconical portion 17b formed integrally on a tip of the cylindrical portion 17a and tapered toward the internal space 12a of the conductive pipe 12. The high voltage electrode 15 extends axially through the portions 17a and 17b such that a tip of the electrode 15 is projected relative to the frustoconical portion 17b by a required amount. The tip of the electrode 15 and the frustoconical portion 17b of the insulator 17 are sheathed by a frustoconical dielectric 19 which is one size larger than the portion 17b of the insulator 17 and is open at its larger-sized end.

The flow passage 14 comprises a tubular portion 14a extending through the support member 16 from outside of the fuel reformer 7, a circular groove 14b formed on a surface of the insulator 18 contacting the support member 16 and coaxially with the dielectric 19 so as to connect with the tubular portion 14a, and a frustoconical through-hole 14c formed axially of the insulator 18, coaxially with the groove 14b and tapered toward the internal space 12a of the pipe 12.

An inner surface of the conductive pipe 12 comprises a curved surface 12b connected at its base end with the tip of the frustoconical through-hole 14c of the insulator 18 and gradually expanding in its inner diameter and a downstream portion which provides a flow passage with a constant inner diameter.

The conductive pipe 12 is formed at its tip with a flange 12c which is connected through an insulator (not shown) with a flange 8a (see FIG. 1) formed on a base end of the injection nozzle 8. The insulator between the flanges 12c and 8a of the pipe 12 and nozzle 8, respectively, may be omitted.

Next, mode of the operation of the above embodiment will be described.

Impressed high voltage (AC high voltage, AC or DC pulse high voltage or the like) between the electrode 15 sheathed at its tip with the dielectric 19 and the conductive pipe 12 as the earth electrode in the fuel reformer 7 shown in FIG. 2 generates low-temperature plasma through barrier discharge, so that the fuel such as light oil, which passes via the tubular flow passage 14 extending through the support member 16, the groove 14b and the frustoconical through-hole 14c of the insulator 18 into the internal space 12a of the conductive pipe 12, is effectively reformed into generation of H₂, CO and the like.

Thus, when the fuel reformer 7 shown in FIG. 2 is arranged upstream of the NOₓ-occlusion reduction catalyst 5 in the exhaust pipe 4 of the diesel engine 1 shown in FIG. 1 to feed the reformed H₂, CO and the like via the injection nozzle 8, the fuel such as light oil can be decomposed into H₂, CO and the like at a temperature lower than that in use of the cracking catalyst, whereby high NOₓ reduction ratio can be obtained even at a lower temperature region.

Thus, the fuel can be efficiently reformed and effectively utilized for reduction of the NOₓ-occlusion reduction catalyst 5.

FIG. 3 is a sectional side elevation showing a second embodiment of the fuel reformer 7. In FIG. 3, the parts similar to those in FIG. 2 are represented by the same reference numerals. The embodiment, which is the same in fundamental structure as the first embodiment shown in FIG. 2, is characteristic as shown in FIG. 3 in that the high voltage electrode 15 is arranged via the electrode-supporting insulator 17 on the support member 16, the base end 19a of the dielectric 19 sheathing the tip of the electrode 15 is eaten into the end face 17c of the cylindrical portion 17a of the insulator 17, a distance from the tip of the electrode 15 to the conductive pipe 12 being made shorter than that between the electrode 15 and the support member 16

In the second embodiment shown in FIG. 3, even if the support member 16 is made of stainless steel or other metal and thus may function as earth electrode, prevented is so-called surface creepage which is electric discharge from the base end 19a of the dielectric 19 via the end face 17c of the cylindrical portion 17a of the insulator 17 along the end face 16a of the support member 16. As a result, barrier discharge can be ensured from the tip of the electrode 15 to the conductive pipe 12 to generate low-temperature plasma, resulting in improvement in effectivity.

FIG. 4 is a sectional side elevation showing a third embodiment of the fuel reformer 7. In FIG. 4, the parts similar to those in FIG. 3 are represented by the same reference numerals. The embodiment, which is the same in fundamental structure with the second embodiment shown in FIG. 3, is characteristic as shown in FIG. 4 in that the end face 17c of the insulator 17 is projected relative to the end face 16a of the support member 16.

In the third embodiment shown in FIG. 4, even if the base end 19a of the dielectric 19 is coplanar with the end face 16a of the support member 16, the base end 19a of the dielectric 19 turns out to be eaten into the end face 17c of the insulator 17, a distance from the base end 19a of the dielectric 19 via the end face 17c of the insulator 17 to the end face 16a of the support member 16 being prolonged. Thus, just like the above, the surface creepage is prevented and barrier discharge can be ensured from the tip of the electrode 15 to the conductive pipe 12 to generate low-temperature plasma, resulting in improvement in effectivity.

FIG. 5 is a sectional side elevation showing a fourth embodiment of the fuel reformer 7. In FIG. 5, the parts similar to those in FIG. 2 are represented by the same reference numerals. The embodiment, which is the same in fundamental structure with the first embodiment shown in FIG. 2, is characteristic as shown in FIG. 5 in that the electrode 15 and the frustoconical portion 17b of the insulator 17 are closely fitted to the dielectric 19 sheathing the tip of the electrode 15 and the portion 17b of the insulator 17, that the tip of the dielectric 19 is formed with a disc-like projection 19b for guidance of the mixed gas 13 to an area generating plasma, that the insulator 18 is increased in thickness to be formed with a curved surface 18a with an inner diameter gradually expanding for connection with the tip of the frustoconical through-hole 14c and that the curved surface 12b of the conductive pipe 12 is smoothly contiguous with the curved surface 18a.

In the fourth embodiment shown in FIG. 5, the electrode 15 is closely fitted without gap to the dielectric 19 sheathing the tip of the electrode 15, so that low-temperature plasma can be generated more effectively. In addition the dielectric 19 sheathing the tip of the electrode 15 is formed at its tip with a disc-like projection 19b for guidance of the mixed gas 13 to the area generating the plasma, so that the mixed gas 13 is reliably guided along the disc-like projection 19b to the area generating the plasma through barrier discharge, which makes its possible to reform the fuel more efficiently.

In addition, by increasing the insulator 18 in thickness to be formed with the curved surface 18a with the inner diameter gradually expanding for connection with the tip of the frustoconical through-hole 14c and by making the curved surface 18a smoothly contiguous with the curved surface 12b of the conductive pipe 12, the joint between the insulator 18 and conductive pipe 12 is out of alignment with the pointed transition from the tip of the frustoconical through-hole 14c to the curved surface 18a in the mixed gas flow passage 14. As a result, the plasma is prevented from being concentrated to the pointed transition and the plasma can be generated in a wide range, which is effective in efficient reformation of the fuel.

FIG. 6 is a sectional side elevation of a fifth embodiment of the fuel reformer 7. In FIG. 6 the parts similar to those in FIG. 5 are represented by the same reference numerals. The embodiment which is the same in fundamental structure with the fourth embodiment shown in FIG. 5, is characteristic as shown in FIG. 6 in that, in lieu of the dielectric 19 sheathing the tip of the electrode 15, only the inner surface of the conductive pipe 12 is covered with a dielectric 19 embedded there and that the tip of the electrode 15 is formed with a disc-like projection 15a for guidance of the mixed gas 13 to the area generating the plasma.

In the fifth embodiment shown in FIG. 6, the low-temperature plasma is generated by barrier discharge between the electrode 15 exposed or not sheathed by a dielectric and the conductive pipe 12 covered or sheathed with the dielectric 19 and, just like the fourth embodiment shown in FIG. 5, the mixed gas 13 is positively guided along the disc-like projection 15a to the area generating the plasma through the barrier discharge, whereby the fuel can be reformed more efficiently.

FIG. 7 is a sectional side elevation showing a sixth embodiment of the fuel reformer 7. In FIG. 7, the parts similar to those in FIG. 6 are represented by the same reference numerals. The embodiment is characteristic as shown in FIG. 7 in that the dielectric 19 is omitted to perform arc discharge between the electrode 15 and the conductive pipe 12. In this case, in lieu of the AC high voltage or the AC or DC pulse high voltage, DC high voltage may be impressed as the high voltage between the electrode 15 and the conductive pipe 12 as the earth electrode.

In the sixth embodiment shown in FIG. 7, high-temperature plasma is generated by the arc discharge, so that the mixed gas 13 is elevated in temperature and is effective for reformation of fuel. In addition, the tip of the electrode 15 is formed with the disc-like projection 15a for guidance of the mixed gas 13 to the area generating the plasma, so that the mixed gas 13 is reliably guided along the disc-like projection 15a to the area generating the plasma through the arc discharges whereby the fuel reformation can be performed more efficiently.

It is to be understood that a fuel reformer of the invention is not limited to the above embodiments and that various changes and modifications may be made without departing from the spirit of the invention. For example, the invention may be applicable not only to reduction of the NOₓ-occlusion reduction catalyst but also other fields such as a fuel cell.

### INDUSTRIAL APPLICABILITY

A fuel reformer of the invention is suitable for a field of reduction of a NOₓ-occlusion reduction catalyst for an exhaust emission control device for a diesel engine or a field of generating, for example hydrogen for use in a fuel cell.

1. A Fuel reformer, comprising an electrically conductive pipe providing an earth electrode,
a mixed gas flow passage for guiding a mixed gas of fuel with air into the conductive pipe and
a high voltage electrode for impression of high voltage between the same and the electrically conductive pipe as the earth electrode so as to generate plasma to reform the fuel guided from said mixed gas flow passage into the conductive pipe.

2. A fuel reformer as claimed in claim 1, wherein at least one of a tip of the high voltage electrode and an inner surface of the conductive pipe is sheathed by a dielectric, barrier discharge being performed between the high voltage electrode and the conductive pipe.

3. A fuel reformer as claimed in claim 2, wherein the high voltage electrode is arranged via an electrode-supporting insulator to a support member, the dielectric sheathing the tip of the high voltage electrode being eaten into an end face of the electrode-supporting insulator, a distance from the tip of the high voltage electrode to the conductive pipe being shorter than that between the high voltage electrode and the support member.

4. A fuel reformer as claimed in claim 3, wherein the end face of the electrode-supporting insulator is projected relative to an end face of the support member.

5. A fuel reformer as claimed in claim 2, wherein the high voltage electrode is closely fitted without gap to the dielectric sheathing the tip of the high voltage electrode.

6. A fuel reformer as claimed in claim 3, wherein the high voltage electrode is closely fitted without gap to the dielectric sheathing the tip of the high voltage electrode.

7. A fuel reformer as claimed in claim 4, wherein the high voltage electrode is closely fitted without gap to the dielectric sheathing the tip of the high voltage electrode.

8. A fuel reformer as claimed in claim 2, wherein the dielectric sheathing the tip of the high voltage electrode is formed at a tip thereof with a disc-like projection for guidance of the mixed gas to the area generating the plasma.

9. A fuel reformer as claimed in claim 3, wherein the dielectric sheathing the tip of the high voltage electrode is formed at a tip thereof with a disc-like projection for guidance of the mixed gas to the area generating the plasma.

10. A fuel reformer as claimed in claim 4, w wherein the dielectric sheathing the tip of the high voltage electrode is formed at a tip thereof with a disc-like projection for guidance of the mixed gas to the area generating the plasma.

11. A fuel reformer as claimed in claim 5, wherein the dielectric sheathing the tip of the high voltage electrode is formed at a tip thereof with a disc-like projection for guidance of the mixed gas to the area generating the plasma.

12. A fuel reformer as claimed in claim 6 wherein the dielectric sheathing the tip of the high voltage electrode is formed at a tip thereof with a disc-like projection for guidance of the mixed gas to the area generating the plasma.

13. A fuel reformer as claimed in claim 7 wherein the dielectric sheathing the tip of the high voltage electrode is formed at a tip thereof with a disc-like projection for guidance of the mixed gas to the area generating the plasma.

14. A fuel reformer as claimed in claim 2, wherein only the inner surface of the conductive pipe is sheathed or covered with a dielectric, the tip of the high voltage electrode being formed with a disc-like projection for guidance of the mixed gas to the area generating the plasma.

15. A fuel reformer as claimed in claim 1, wherein arc discharge is performed between the high voltage electrode and the conductive pipe.

16. A fuel reformer as claimed in claim 15, wherein the tip of the high voltage electrode is formed with a disc-like projection for guidance of the mixed gas to the area generating the plasma.

17. A fuel reformer as claimed in claim 1, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

18. A fuel reformer as claimed in claim 2, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

19. A fuel reformer as claimed in claim 3, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

20. A fuel reformer as claimed in claim 4, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

21. A fuel reformer as claimed in claim 5, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

22. A fuel reformer as claimed in claim 6, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding the curved surface being smoothly contiguous with the inner surface of the conductive pipe.

23. A fuel reformer as claimed in claim 7 wherein the conductive pipe is arranged via an pipe-supporting insulator to a support member a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

24. A fuel reformer as claimed in claim 8, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

25. A fuel reformer as claimed in claim 9, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

26. A fuel reformer as claimed in claim 10, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

27. A fuel reformer as claimed in claim 11, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

28. A fuel reformer as claimed in claim 12, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

29. A fuel reformer as claimed in claim 13, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

30. A fuel reformer as claimed in claim 14, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

31. A fuel reformer as claimed in claim 15, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.

32. A fuel reformer as claimed in claim 16, wherein the conductive pipe is arranged via an pipe-supporting insulator to a support member, a frustoconical through-hole as a mixed gas flow passage extending through said pipe-supporting insulator coaxially with the high voltage electrode and tapered toward an internal space of the conductive pipe, a curved surface being formed from the tip of the frustoconical through-hole and having an inner diameter gradually expanding, the curved surface being smoothly contiguous with the inner surface of the conductive pipe.
